(19) United States
(12) Patent Application Publication
(10) Pub. No.: US 2015/0238877 A1
(43) Pub. Date: Aug. 27, 2015

(54) LANGUAGE TRANSLATING DOLL

(71) Applicant: Ricardo Abundis, Costa Mesa, CA (US)

(72) Inventor: Ricardo Abundis, Downey, CA (US)

(21) Appl. No.: 14/542,538

(22) Filed: Nov. 14, 2014

Related U.S. Application Data
(60) Provisional application No. 61/904,170, filed on Nov. 14, 2013.

(51) Int. Cl. A63H 3/28; G09B 19/06

(52) U.S. Cl. CPC A63H 3/28; G09B 19/06

(57) ABSTRACT

The present invention language translating doll provides a doll preferably costumed in a manner representative of a particular nation or language speaking area within which a speech recognition apparatus is supported. The doll further supports an audible speech receiving apparatus such as a microphone together with an audible speech output apparatus such as an electro-acoustic transducer such as a speaker. A processor or controller within the doll is coupled to the audible speech receiving apparatus and to the audio speech output apparatus and is operative to receive audible speech in a spoken language from the child user and immediately thereafter audiblize and speak the translated word or phrase in an alternative language. The doll may be voice activated or respond to a pressure sensitive switch supported upon the doll body.

### CROSS-REFERENCE TO RELATED APPLICATION

This application claims the benefit of and priority under 35 U.S.C. 119(e) of U.S. Provisional Patent Application No. 61/904,170 entitled LANGUAGE TRANSLATING DOLL, filed Nov. 14, 2013 in the name of Ricardo Abundis, the disclosure of which is incorporated herein by reference.

### FIELD OF THE INVENTION

This invention relates generally to dolls and toy figures and relates particularly to dolls and toy figures having language or speaking capability. The present invention further relates to language translation apparatus.

### BACKGROUND OF THE INVENTION

Dolls and toy figures have proven to be an exceedingly popular and long-lasting type of toy apparatus. The continued and extensive popularity of dolls and toy figures have prompted practitioners in the art to provide a virtually endless variety of such dolls and toy figures. For the most part, the terms doll and toy figure may be used virtually interchangeably and refer to a toy product which resembles a human, a human infant, or an animal or fanciful representation. Thus, as used herein the term “doll” will be understood to refer collectively and interchangeably to these various types of dolls and toy figures.

The extensive variety of dolls provided in the art has included dolls which utilize extremely complex coverings and costumes to produce a variety of aesthetic appeals. Additionally, dolls have been provided which may use of the rapid advance in the technology fields relating to mechanics, movement mechanisms, electronic circuitry and digital electronic systems which have included voice recognitions, speech systems, speech synthesis systems and verbally interactive toys and dolls. The rapid advances in such technology areas has greatly increased the capabilities which may be provided within a commercially available doll product.

Accordingly, equipped with the great advances in the above technologies and facing the need for ever more improved dolls, practitioners in the art have provided dolls which move, speak, sing, dance, interact, respond to stimuli and provide teaching or educational benefits. One example of such teaching and educational dolls is set forth in U.S. Pat. No. 5,816,821 issued to Ouellette which sets forth BILINGUAL EDUCATIONAL DOLLS that aid in teaching children additional languages. Each doll has characteristics and costume depicting a specific recognizable nation in both male and female depiction. The dolls are provided with an accessory consisting of an interactive sound transmitting and recording device. Prerecorded music with educational song lyrics are synchronized with the recording mechanism such that songs are sung in English and thereafter immediately repeated in a second language corresponding to the nation depicted by the male and female characters.

U.S. Pat. No. 6,869,286 issued to Furry sets forth a LANGUAGE LEARNING SYSTEM which includes a set of fictional characters, each character being associated with a predetermined phoneme of a language such as English. The character typically has a given name including the phoneme. The system may further include a learning device configured to display at least one of the characters along with an associated letter corresponding to the phoneme.

U.S. Pat. No. 6,882,824 issued to Wood sets forth an INTERACTIVE TEACHING TOY which includes a figure having an external surface and defining an animal-like anatomy including chest, hands and feet. A plurality of switch actuators are supported about the figure and coupled to a sound synthesizer, a speaker, a memory, a plurality of programmed instruction modalities, all of which cooperate to provide microprocessor sound as the sensors are activated.

U.S. Pat. No. 6,554,616 issued to Love sets forth a BILINGUAL DOLL constructed for teaching young children specifically desired and selected words or phrases of a language other than the primary language spoken in the home.

U.S. Pat. No. 6,959,166 issued to Gabai et al sets forth an INTERACTIVE TOY that relates to computer systems and methods generally and more particularly to development of interactive constructs, to techniques for teaching such development, and to verbally interactive toys.

While the foregoing described prior art devices have to some extent improved the art and in some instances have enjoyed commercial success, there remains none the less a need in the art for a doll which assists a child user in learning particular words and phrases in a second language.

### SUMMARY OF THE INVENTION

Accordingly, it is a general object of the present invention to provide an improved interactive doll capable of speaking multiple languages. It is a more particular object of the present invention to provide an improved interactive doll utilizing such multi language capability to provide instructive translation of selected languages in interacting with a child user.

Thus, the present invention language translating doll provides a doll preferably costumed in a manner representative of a particular nation or language speaking area within which a speech recognition apparatus is supported. The doll further supports an audible speech receiving apparatus such as a microphone together with an audible speech output apparatus such as an electro-acoustic transducer such as a speaker. A processor or controller within the doll is coupled to the audible speech receiving apparatus and to the audio speech output apparatus and is operative to receive audible speech in a spoken language from the child user and immediately thereafter audiblize and speak the translated word or phrase in an alternative language. The doll may be voice activated or respond to a pressure sensitive switch supported upon the doll body.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a front view of a language translating doll constructed in accordance with the present invention;

FIG. 2 sets forth an operational block diagram of the operating system within doll 10 by which it performs the language translating function;

FIG. 3 sets forth a pictorial representation of a plural doll set constructed in accordance with the present invention;

FIG. 4 sets forth a block diagram of the operative system of an alternate embodiment of the present invention doll; and

FIG. 5 sets forth a flow diagram of the operation of the alternate embodiment of the present invention doll set forth in FIG. 4.

### DESCRIPTION OF THE PREFERRED EMBODIMENTS

By way of overview, the present invention provides a language translating doll fashioned to represent a particular nation or style of dress which is associated with an alternate language. The doll supports an operative electronic system which includes apparatus for receiving audible speech from the child user together with apparatus for producing output audible speech which may be heard by the child user. The operational system within the doll includes a controller which functions to receive spoken words or phrases from the child user and convert it to appropriate digital electronic signals. The controller further performs a speech recognition function to convert the received speech to a corresponding set of digital signals. The controller then utilizes the digital speech representing signals to access a corresponding set of speech signals which conforms to the identical word or phrase translated to an alternative language. The controller then converts the alternate language digital signals to audible speech of the words or phrases in the alternate language and applies it to the system speaker. As a result, the child user speaks in a first language to the doll and immediately hears the doll “speak” the identical phrase or language translated speech in the alternate language. The system may operate without manual input utilizing voice activated apparatus or alternatively may utilize pressure responsive sensors located on the doll body for activating the system and controlling its operation.

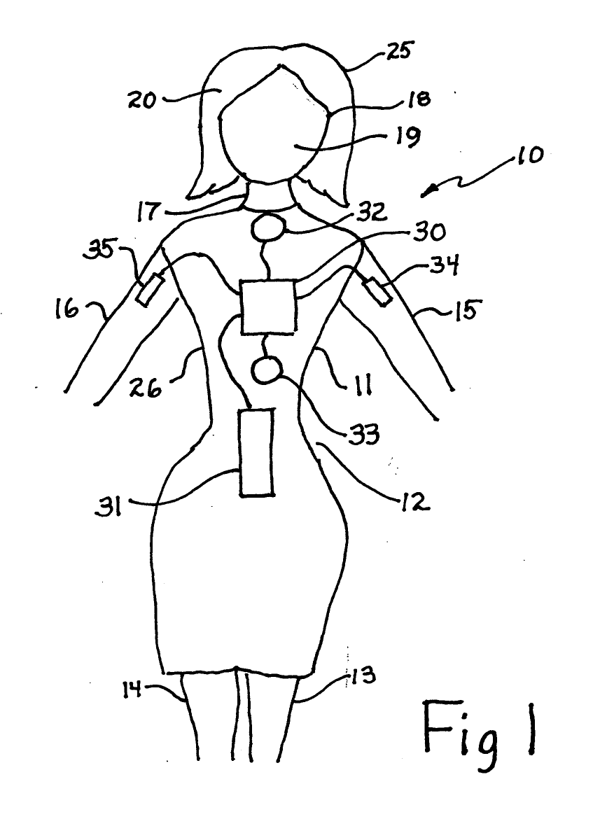

More specifically, FIG. 1 sets forth a front view of a language translating doll constructed in accordance with the present invention and generally referenced by numeral 10. Doll 10 depicts a “fashion doll” characterized by a relatively thin youthful body and a high fashion costume. However, it will be apparent to those skilled in the art that doll 10 may be configured to provide virtually any appearance without departing from the spirit and scope of the present invention. Thus, it will be understood that doll 10 may, for example, represent a human infant or alternatively an animal figure or even a fanciful non-human non-animal figure such as a robot or alien creature without departing from the spirit and scope of the present invention.

Doll 10 includes a body 11 preferably formed of a molded plastic material or other commercially utilizable fabrication. Doll 10 further includes a waist portion 11 which in turn supports a pair of legs 13 and 14. Doll 10 also includes a pair of arms 15 and 16 together with a neck 17. A head 18 supporting a face 19 is joined to the remainder of body 11 by an upwardly extending neck 17. A quantity of simulated hair 20 is secured to head 18 and a hat 25 is received upon head 18 and hair 20. To complete the outward appearance of doll 10, a dress 26 suitably costumed to represent the alternative language identifying region or national character is supported upon doll 10. By way of example and not limitation, dress 26 may produce the appearance of a Mexican, South American or Spanish individual to suggest the Spanish language as the alternative speech. However, it will be apparent that other differently themed dresses may be supported upon doll 10 to represent or suggest other languages. Thus, dress 26 may, for example, be conformed to a German or other European individual to suggest German language or other European languages.

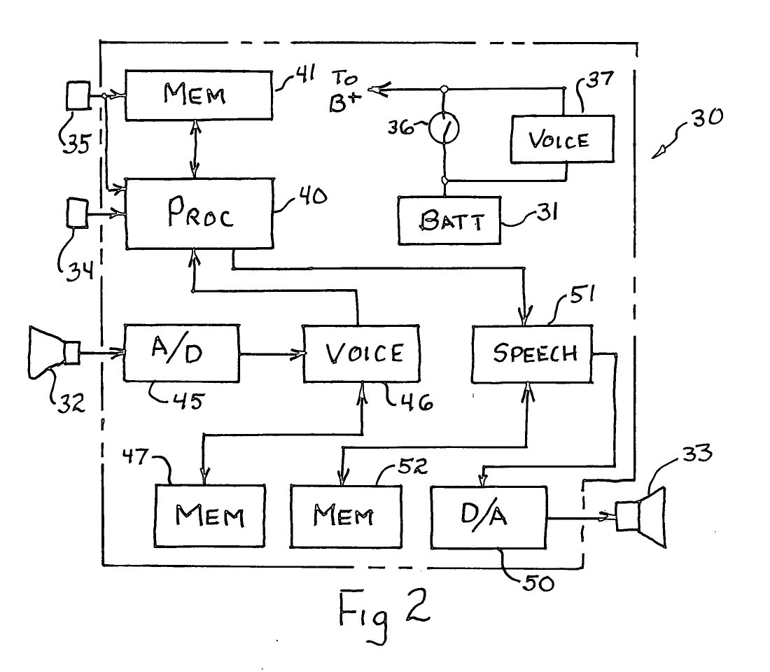

Doll body 11 defines an interior cavity constructed in accordance with conventional fabrication techniques which in turn supports an operative controller 30. Controller 30 is set forth below in FIG. 2 showing the operative block diagram thereof. Suffice it to note here that controller 30 includes otherwise conventional fabrication digital electronic circuitry which includes digital to analog converters, speech recognition circuitry, speech synthesis circuitry, a microprocessor and a microprocessor memory having a stored instruction set or program for operating the microprocessor therein. The operative apparatus within doll body 11 also includes a microphone 32 for receiving audible speech and a speaker 33 for producing audible speech. Additionally, an internal battery power supply 31 is supported within body 11. A pair of pressure responsive sensors 34 and 35 are supported within arm's 15 and 16 and are operatively coupled to controller 30. Thus, it will be apparent to those skilled in the art that doll 10 is a “stand alone” doll which does not require coupling to any further operative apparatus such as a computer or the like.

In operation, controller 30 together with microphone 32, speaker 33 operates in response to battery power provided from battery circuit 31 to provide doll 10 with the capability of receiving audible speech spoken by the child user and responding by producing audible voice output in a different or alternative language which may be heard by the child user. The operation of controller 30 is described below in greater detail. However, the effect during the anticipated play pattern experienced by the child user includes the learning activity by which the user speaks to the doll in the user's normal language and thereafter immediately hears the doll repeat the same words or phrases in an alternate language. Thus, if the primary language is English and the alternate language is Spanish, the child user speaks to doll 10 in English and thereafter hears doll 10 repeat the spoken words or phrases in Spanish.

FIG. 2 sets forth an operative block diagram of controller 30 and its associated circuitry. As described above, controller 30 operates in combination with microphone 32 and speaker 33 to receive voice words and phrases and to voice translations of each word or phrase in an alternate language. Accordingly, controller 30 is constructed in accordance with conventional fabrication techniques and includes a processor 40 having an associated memory 41 coupled thereto. An analog to digital signal converter 45 is coupled to microphone 32 and to a voice circuit 46. Voice circuit 46 is a conventional voice signal processor and is coupled to a speech memory 47. The output of voice circuit 46 is coupled to processor 40.

Controller 40 further includes a digital to analog signal converter 50 which in turn is coupled to a speech synthesizer circuit 51. Speech synthesizer circuit 51 is conventional in fabrication and is coupled to a speech memory 52. The input of speech synthesizer 51 is coupled to processor 40.

A pair of pressure-responsive switches 34 and 35 are coupled to processor 40. Controller 40 also includes a battery power supply 31 which is operatively coupled to the power inputs of the circuits within controller 40 through an on/off switch 36. Additionally, a voice activated switch 37 is coupled to battery 31 to allow doll 10 to be activated by voice command.

In operation, controller 30 is activated by switch 36 or voice activation switch 37. Thereafter, the user speaks a word, or phrase in the user's normal language which is received by microphone 32. The received speech is converted to a corresponding digital signal by analog to digital converter 45. In response to the digital speech signal from converter 45, voice circuit 46 determines the corresponding word or phrase stored within memory 47 and couples it to processor 40. Processor 40 then looks up the corresponding word or phrase in the alternate language within memory 41. Processor 40 thereafter couples the alternate language signal to speech synthesizer 51 which, in turn, forms the corresponding alternate language speech signal. Digital to analog converter 50 the converts the digital output signal from speech synthesizer 51 to an analog signal which drives speaker 33 to produce audible translated speech. The user then hears the doll repeat the spoken word or phrase in the alternate language.

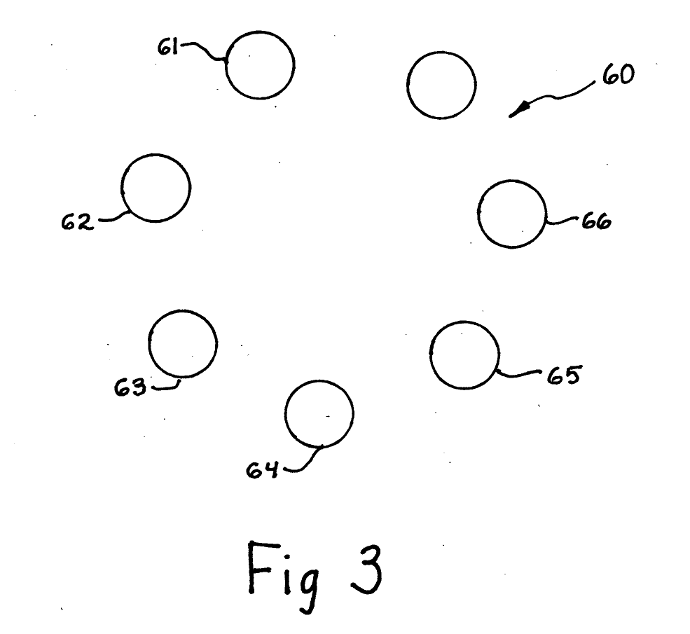

FIG. 3 sets forth a pictorial representation of a plural doll game set constructed in accordance with the present invention. Each of the dolls set forth in FIG. 3 are of the same construction and are preferably formed as a fashion doll such as doll 10 shown above in FIG. 1. In addition, each doll is preferably fashioned and dressed to suggest the appearance of a country or local related to the alternate language that the doll speaks. Thus, with particular attention to FIG. 3, a plurality of dolls forms a doll game set generally referenced by numeral 60. Doll game set 60 includes a doll 61 which is named Ari and is Italian in appearance. Ari speaks English as a primary language and Italian as an alternate language. Doll 62 which is named Meili is Chinese in appearance. Meili speaks English as a primary language and Chinese as an alternate language. Doll 63 which is named Gigi is French in appearance. Gigi speaks English as a primary language and French as an alternate language. Doll 64 which is named Charli is German in appearance. Charli speaks English as a primary language and German as an alternate language. Doll 65 which is named Rae is Russian in appearance. Rae speaks English as a primary language and Russian as an alternate language. Doll 66 which is named Mia is Portuguese in appearance. Mia speaks English as a primary language and Portuguese as an alternate language. And finally, doll 67 which is named Lola is Spanish in appearance and speaks English as a primary language and Spanish as an alternate language.

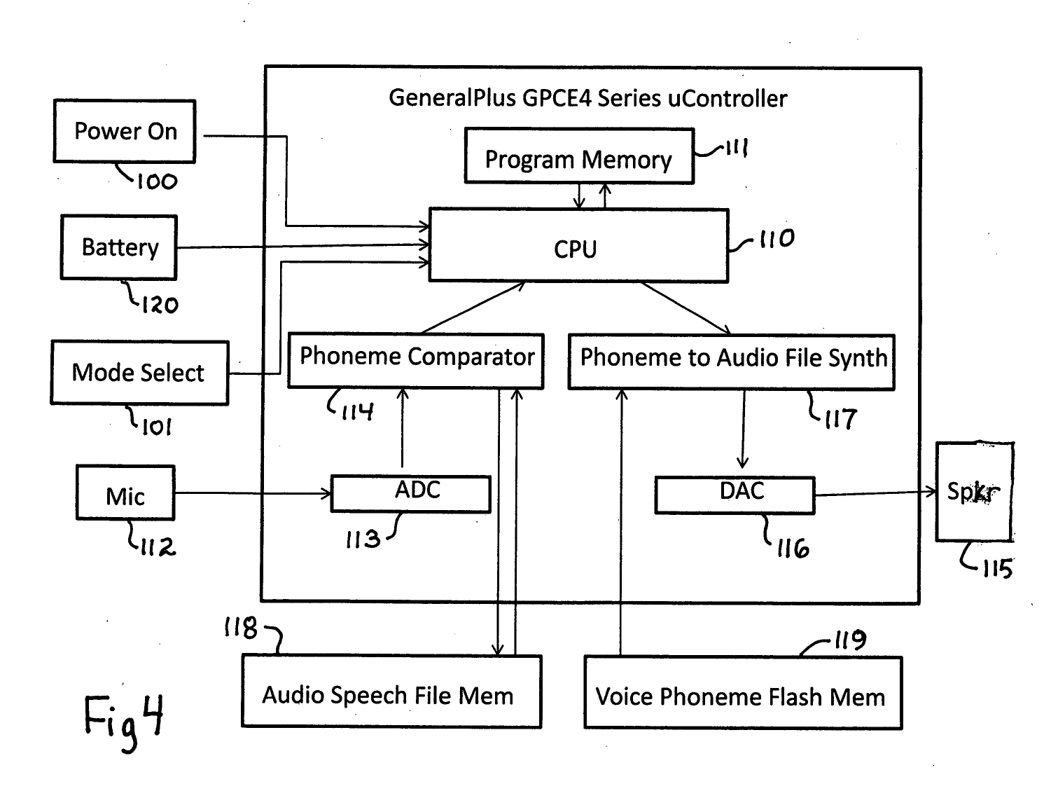

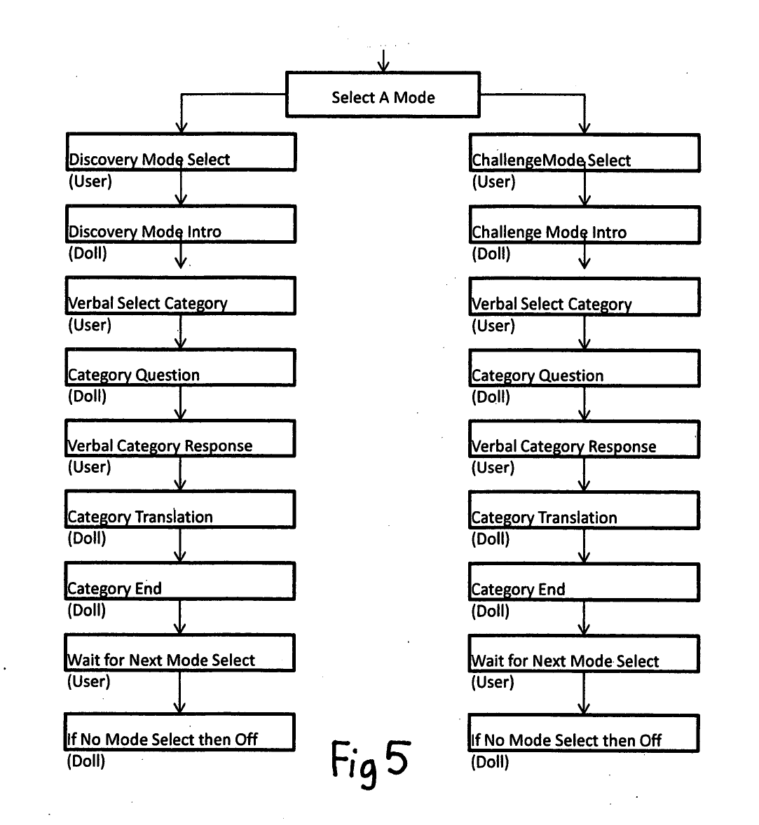

Each of dolls 61 through 67 is controlled and operated by the circuit set forth in FIG. 4 and the flow diagram set forth in FIG. 5. In the game play of the present invention, the user selects one of dolls 61 through 67 to handle and interact with. When the user selects one of dolls 61 through 67, the user is, in fact, also selecting the alternate language which will be the translated language of the game play. Thus, for example, if the user selects doll 63 (Gigi), the alternate language of the game play will be French. The user initiates game play by turning doll 63 on using power switch 100 (seen in FIG. 4) and choosing a mode using switch 101 (seen in FIG. 4). Once the selected doll is activated and a mode is selected, the doll, doll 63, asks the user to choose one of the remaining dolls to set up the game. The user may, for example, speak the doll name “Lola” (doll 67). By means described below, the user selection of Lola (doll 67) performs a selection of a group of speech segments which will be used in the game play. As the game play progresses, word segments are translated between English and French, and between French and English, depending on the mode selected by the user. The operation of game play in each mode is set forth below in conjunction with FIG. 5. However, suffice it to note here that choosing the “discovery” mode provides translation of the user's English speech into French while selection of the “challenge” mode requires the user to translate French spoken by doll 63 into English.

It will be noted that should the user select a different doll, for example, doll 65 (Rae), the alternate language would be Russian. Also, the selection of a different friend, for example Ari (doll 61), selects a different set of speech segments to be used in the game play. Thus, it will be understood that the user selects the alternate language of translation by selecting a particular doll and selects a set of words or phrases, speech segments, by selecting a particular doll as a friend.

FIG. 4 sets forth a block diagram of the operative circuit within dolls 61 through 67. A central processing unit (CPU) 110 is fabricated in accordance with conventional techniques and is coupled to an associated memory 111. Memory 111 stores the controlling program operative in accordance with the flow diagram shown in FIG. 5. A power switch 100 activates the system while a battery 120 supplies operative power. A mode select switch 101 sets the desired mode of operation. A microphone 112 provides audio input to an analog to digital converter 113 which, in turn, is coupled to a phoneme comparator 114. Phoneme comparator 114 converts the digital signals from converter 113 to appropriate digital in put information to CPU 110.

CPU 110 retrieves the digital speech information from memory 111 and applies it to phoneme to audio synthesizer 117 which converts the signals to appropriate digital audio signals for speech. A digital to analog converter 116 converts the digital signals to corresponding analog signals suitable for driving a speaker 115 producing doll audible speech. An audio speech file 118 provides a data base for comparator 114 while a voice phoneme flash memory 119 stores phoneme data. By operation of the system shown in FIG. 4, the present invention dolls are able to “hear” speech from the user and speak to the user. CPU 110 controls the doll operation and game play.

FIG. 5 sets forth the flow diagram of the present invention doll translation and game play.

What has been shown is a translating doll which the user speaks to in the user's normal language and hears an immediate translation of the spoken word or phrase in an alternate language. The result is a simple, easily operated translation doll which provides amusement and education activities simultaneously.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A speech translating doll game comprising:
a first speech translating doll having;
a first doll body;
a first controller having a first associated memory;
a first battery;
a first operating switch selectable between a discovery mode, a challenge mode and a power off position;
a first audible speech input receiver;
a first plurality of speech segments in a primary language stored in a first speech file memory; and
a second plurality of speech segments in a first alternate language stored in said first speech file memory, said first and second pluralities of speech segments each being translations of eachother.
